(19) United States
(12) Patent Application Publication
(10) Pub. No.: US 2007/0079885 A1
(43) Pub. Date: Apr. 12, 2007

(54) Hose assembly

(75) Inventors: Stephen J. Zaborszki, Northfield Center, OH (US); Paul D. Meeker, Mantua, OH (US); Joseph E. Ludwig, Solon, OH (US); Charles T. Simmons, Kent, OH (US); Arnold W. Bervish, Windham, OH (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Wayne, NJ (US)

(21) Appl. No.: 11/247,966

(22) Filed: Oct. 11, 2005

(51) Int. Cl. F16L 11/00

(52) U.S. Cl. 138/121; 138/122; 138/109; 285/256

(57) ABSTRACT

The disclosure is directed to a hose assembly including a corrugated metal hose having an inner surface defining a lumen and an outer surface and a polymeric layer surrounding the outer surface of the corrugated metal hose.

### FIELD OF THE DISCLOSURE

This disclosure generally relates to hose assemblies and methods for manufacturing hose assemblies.

### BACKGROUND

Many chemical and energy systems use small molecule gases, such as hydrogen, helium, nitrogen, and oxygen. Such systems include refrigeration systems and fuel cell systems. Often, these systems are manufactured to be portable or have a small foot print and, owing to their compact nature, use flexible hosing assemblies for small molecule gas transport.

Typically, flexible hosing assemblies include metal corrugated hose having a braided metal wire covering. However, in mechanically demanding applications, such as portable systems, these flexible hosing assemblies tend to wear and malfunction. For example, the braided metal covering may fray at bends or separate from couplings, allowing the corrugated metal hose to elongate. With elongation and movement of the corrugations, the metal corrugations wear and form holes and leaks. In addition, vibration and severe flexing may cause wear and leaking. As such, improved flexible hosing suitable for small molecule gases would be desirable.

### SUMMARY

In a particular embodiment, the disclosure is directed to a hose assembly including a corrugated metal hose and a polymeric layer surrounding the outer surface of the corrugated metal hose. The corrugated metal hose has an inner surface defining a lumen and has the outer surface

In another embodiment, the disclosure is directed to a conduit including a barrier layer and a polymeric layer having a surface substantially in contact with a surface of the barrier layer.

In a further embodiment, the disclosure is directed to a method of manufacturing a conduit. The method includes coupling a nipple to a corrugated hose and sheathing a polymeric hose over the corrugated hose and at least a portion of the nipple.

### BRIEF DESCRIPTION OF THE DRAWINGS

The present disclosure may be better understood, and its numerous features and advantages made apparent to those skilled in the art by referencing the accompanying drawings.

FIGS. 1 and 2 is a diagram depicting exemplary embodiments of a hose assembly.

FIG. 3 is a flow diagram depicting an exemplary method for manufacturing a hose assembly.

### DESCRIPTION OF THE PREFERRED EMBODIMENT(S)

In a particular embodiment, the disclosure is directed to a flexible hose assembly including an inner metal hose and a polymeric hose. The inner metal hose is formed of corrugated metal construction. The hose assembly may also include a non-metallic reinforcement layer.

The metal hose may be formed of elemental metal or an alloy. Particular materials include bronze, steel (including carbon steel and stainless steel), copper nickel alloys including Monel® alloys, titanium alloy, and other metals and metal alloys. The metal hose generally has a corrugated construction, such as annular and helical corrugations. Annular hose construction includes a series of full 360-degree corrugations consisting of a root radius, sidewalls, and a crest radius. The sidewalls of each corrugation extend from an inner root radius to the outer crest radius and back to the inner root radius. Each convolution is a complete, repeating structural unit. In contrast, helical hose construction denotes a plurality of corrugations being formed by a single, continuous corrugation that extends along the longitudinal axis of the hose. It is noted that while oftentimes helical constructions have a single helix defining all corrugations, multiple helix sections may be incorporated, together defining the length of the hose.

Annular corrugated constructions may be manufactured from a cylindrical, thin walled tube. A corrugated annular profile is typically impressed into the tube. Helical corrugated constructions may be formed by strip winding and continuously welding a shaped strip of material. In another example, helical corrugated constructions may be formed by rotating a tube through an annular die. Annular corrugated hoses are generally less susceptible than helical hoses to damage from torsional stress due to longitudinal expansion resulting from pressure rises, and are therefore preferred for certain applications.

The polymeric hose may be formed of thermoplastic or thermoset polymers. The polymer may be elastomeric or non-elastomeric. An exemplary polymer includes polytetrafluoroethylene, silicone, neoprene, nylon 6, nylon 11, nylon 12, polyester, polyethylene, thermoplastic vulcanizates, polyurethane, or polyvinylidene fluoride.

The hose may also include a reinforcement layer. The reinforcement layer may be formed of fibrous materials and may include braided fibers or woven fabric. In one exemplary embodiment, the reinforcement layer includes non-metallic fibers, such as polymeric fibers, carbon fibers, or glass fibers. Polymer fibers may include a fiber formed of aramid, polyester, polyamide, polypropylene, polyethylene, or poly vinyl alcohol. Carbon fibers may, for example, include graphite fibers.

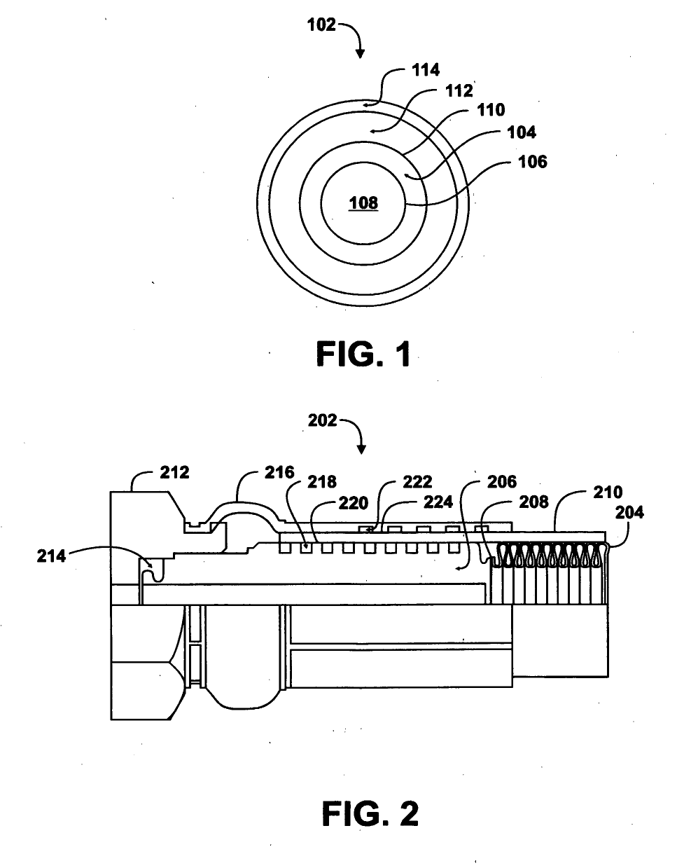

FIG. 1 illustrates an exemplary embodiment of a hose assembly or fluid conduit. The hose assembly 102 includes a corrugated metal hose 104 including an inner surface 106 and an outer surface 110. The inner surface 106 of the metal hose 104 defines an inner conduit lumen 108. The metal hose 104 is a corrugated hose in which the peaks and valleys of the corrugations form the outer most diameter and the inner most diameter of the hose, respectively.

A polymeric layer 112 surrounds the metal layer 104. In FIG. 1, the polymeric layer 112 is in direct contact with the outer surface 110 of the metal hose 104. The polymeric layer may be formed of thermoplastic polymer. The polymer may be elastomeric or non-elastomeric. In one exemplary embodiment, a polymer hose is formed and sheathed over the metal corrugated hose.

The fluid conduit 102 also includes a reinforcement layer 114. In one embodiment, the reinforcement layer 114 includes fibers, such as non-metallic fibers, for example, polymeric fibers or carbon fibers. The fibers may be braided or woven. For example, the reinforcement layer 114 may be braided strands or woven fabric. In one embodiment, the reinforcement layer 114 forms a tubular sheath of braided strands or woven fibers. In an alternative embodiment, the reinforcement layer 114 may be attached to or integrated with the polymeric layer 112. While the precise structure of the reinforcement layer may vary, it generally functions to prevent unwanted elongation of the hose, such as where the corrugations are compromised and partially flattened. In a particular embodiment, the braided or woven strands are applied at an angle, such as about 45° to about 60° measured from the hose centerline. For example, the angle may be about 50° to about 55°, and, in a particular example, 54°. Application of the braided or woven strands at an angle may function to balance created by internal pressure, such as to balance the end load force with the hoop stress in the reinforcement.

FIG. 2 illustrates another embodiment of a conduit or hose assembly 202. The hose assembly 202 includes a corrugated metal hose 204. In this exemplary embodiment, the corrugated metal hose 204 is coupled to a nipple 206. For example, the corrugated metal hose 204 is attached to the nipple 206 by an orbital butt weld at location 208.

A polymer hose 210 may be sheathed over the nipple 206 and the corrugated metal hose 204. The polymer hose 210 generally covers the corrugated metal hose 204 and a portion of the nipple 206. The polymer hose 210 may be in direct contact with the nipple 206 and the corrugated metal hose 204. In one exemplary embodiment, the polymer hose 210 may be coupled to the nipple 206 with the use of a crimp shell 216, as described below. In addition, a reinforcement layer (not shown in FIG. 2, but shown in FIG. 1), such as a braided tubular sheath may be sheathed over the polymeric hose 210 and the portion of the nipple 206. The reinforcement layer may be secured to the polymeric hose 210 or the nipple 206 via a crimping mechanism.

In the embodiment shown, an adaptor 212 is coupled to the nipple 206. While attachment methods may vary, the nipple 206 includes threads for engaging complementary threads of adaptor 212. The adaptor 212 and the nipple are configured to receive a sealing member 214, such as an o-ring. In one particular embodiment, the adaptor 212 may form a portion of a standard connector or may be adapted with additional components to form a portion of a standard connector.

In one exemplary embodiment, a crimp shell 216 secures the polymeric layer 210 and optionally the reinforcement layer to the nipple 206. In FIG. 2, the crimp shell 216 includes recesses 222 and protrusions 224 that hold the layers in place when the crimp shell 216 is crimped over the polymeric layer 210. That is, the crimping forces directed radially by the crimp shell prevent relative translational movement between the polymeric layer 210 and the corrugated metal hose 204. Similarly, the nipple 206 may include recesses 218 and protrusions 220 to secure layers, notably the polymeric layer 210, crimped between the crimp shell 216 and the nipple 206. As shown, the crimp shell 216 may be crimped over a portion of the adaptor 212.

In FIG. 2, the polymeric hose 210 is sheathed over a portion of both the nipple 206 and the corrugated metal hose 204. Optionally, a reinforcement layer as noted above may be sheathed over the polymeric layer 210 and the portion of the nipple. A crimp shell 216 may be crimped over the polymeric layer 210 and the reinforcement layer if present.

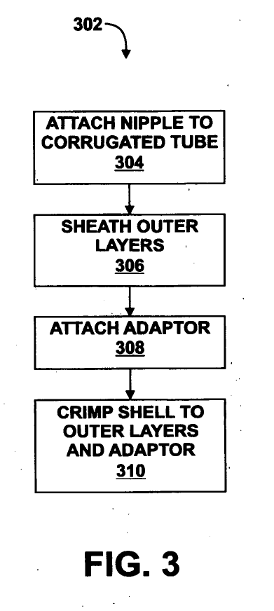

FIG. 3 illustrates an example method 302 for manufacturing a hose assembly. A corrugated metal hose is attached to a nipple, as shown at step 304. For example, a length of corrugated hose may be formed and nipples attached to either end of the length of corrugated hose. In one exemplary embodiment, the corrugated hose is welded to the nipple, such as through butt-welding. For example, the corrugated hose may be cut at a crest of a corrugation, a die may be attached, and the corrugated hose may be cut to a flare. The corrugated hose may be attached to the nipple using an orbital butt weld.

Outer layers are sheathed over the nipple and corrugated metal hose, as shown at step 306. For example, a polymeric layer may be sheathed over the nipple and corrugated metal hose. In addition, a reinforcement layer may be sheathed over the polymeric layer. In an alternative embodiment, the polymeric layer and the reinforcement layer may be together sheathed over the nipple and corrugated metal hose. In one particular embodiment, the outer layers are sheathed over the corrugated metal hose and the nipple such that the outer layers overlie a portion of the nipple.

An adaptor is attached to the nipple, at step 308. For example, the adaptor may be threaded to the nipple. A seal may be formed with an o-ring or other sealing member disposed between the adaptor and nipple.

At step 310, a shell is crimped over the outer layers and the portion of the nipple. In addition, the shell may be crimped over a portion of the adaptor. The shell and the nipple may include recesses and protrusions to secure the outer layers in place.

In one particular embodiment, the conduit or hose assembly may be adapted for high pressure transfer of small molecule gases, such as helium and hydrogen. For example, the conduit may have a leak rate of not more than 10⁻⁶ standard cubic centimeters per second (scc/s), such as not more than 10⁻⁷ scc/s, 10⁻⁸ scc/s or 109 scc/s, for small molecule gases, such as helium or hydrogen. In contrast plastic hoses typically have a leakage rates for small molecule gases of greater than 10−3 SCC/S.

In one exemplary embodiment, the conduit or hose has a pressure rating of greater than about 350 psi at 70° C. For example, the conduit may have a pressure rating even higher, such as at least about 400 psi, at least about 650 psi, or at least about 850 psi. Other embodiments provide higher pressure ratings, such as at least about 1000 psi, at least about 1250 psi, or even at least about 1450 psi.

The conduit or hose may have a low weight per foot for a particular nominal diameter and working pressure. In an exemplary embodiment, a half-inch nominal diameter hose with a working pressure rating of about 3500 psi to about 4000 psi has a weight not greater than about 0.69 lb/ft, such not greater than about 0.65 lb/ft, and, in particular not greater than about 0.63 lb/ft.

In a particular embodiment, a polyester fiber braid overlies an elastomeric polyester core, which surrounds a corrugated metal hose, such as a stainless steel annular corrugated hose. In another particular embodiment, an aramid fiber braid overlies a nylon inner core, which surrounds a corrugated metal hose. In an example the corrugated metal hose has an annular construction. In another example, the corrugated metal hose has a helical construction. In a further particular embodiment, a polyester fiber braid is sheathed over a polyurethane core, which surrounds a corrugated metal hose.

Particular embodiments of the above described hose provide improved impact resistance and resistance to leaks caused by external impact when compared to typical hoses for a selected nominal diameter and pressure rating. Particular embodiments also exhibit reduced weight per unit length when compared to typical hoses for a selected nominal diameter and pressure rating. Further, particular embodiments are less expensive to produce than typical hoses having comparable nominal diameter and pressure rating.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A hose assembly comprising:
a corrugated metal hose having an inner surface defining a lumen and having an outer surface; and
a polymeric layer surrounding the outer surface of the corrugated metal hose.

2. The hose assembly of claim 1, further comprising a fibrous reinforcement layer.

3. The hose assembly of claim 2, wherein the fibrous reinforcement layer surrounds an outer surface of the polymeric layer.

4. The hose assembly of claim 2, wherein the fibrous reinforcement layer comprises braided fibers.

5-8. (canceled)

9. The hose assembly of claim 1, wherein the polymeric layer comprises thermoplastic polymer.

10. The hose assembly of claim 1, wherein the polymeric layer comprises thermoset polymer.

11. The hose assembly of claim 1, wherein the polymer layer comprises polyurethane.

12. The hose assembly of claim 1, wherein the polymer layer comprises nylon.

13. The hose assembly of claim 1, wherein the hose assembly has a leakage rate of no more than 10⁻⁷ scc/s for small molecule gas.

14. A conduit comprising:
a barrier layer, having a leakage rate of no more than 10⁻⁷ scc/s for He; and
a polymeric layer in direct contact with the barrier layer.

15. The conduit of claim 14, wherein the barrier layer exhibits a leakage rate of no more than 10₋₇ scc/s for H₂.

16. The conduit of claim 14, wherein the barrier layer comprises metal.

17. The conduit of claim 14, wherein the barrier layer comprises corrugated metal.

18. The conduit of claim 14, wherein the barrier layer has an inner surface defining a lumen and an outer surface and wherein the surface of the polymeric layer is substantially in contact with the outer surface.

19. The conduit of claim 14, further comprising a reinforcement layer.

20-32. (canceled)

33. A method of manufacturing a conduit, the method comprising:
coupling a nipple to a corrugated hose; and
sheathing a polymeric hose over the corrugated hose and at least a portion of the nipple.

34. The method of claim 33, further comprising sheathing a fibrous reinforcement layer over the polymeric hose.

35-36. (canceled)

37. The method of claim 33, further comprising attaching an adaptor to the nipple.

38. The method of claim 37, further comprising crimping a crimp shell over the adaptor and a portion of the polymeric hose that overlies the portion of the nipple.

39-40. (canceled)

41. The method of claim 33, wherein coupling the nipple to the corrugated hose comprises an orbital butt welding the corrugated hose to the nipple.

42-43. (canceled)
